(19) United States
(12) Patent Application Publication
(10) Pub. No.: US 2006/0220912 A1
(43) Pub. Date: Oct. 5, 2006

(54) Sensing apparatus for vehicles

(76) Inventors: Adam John Heenan, Sheffield (GB); Andrew Oghenovo Oyaide, Birmingham (GB)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/345,598

(22) Filed: Jan. 31, 2006

Related U.S. Application Data
(63) Continuation of application No. PCT/GB04/03291, filed on Jul. 29, 2004.

(30) Foreign Application Priority Data
Jul. 31, 2003 (GB) 0317949.6

(51) Int. Cl. G08G 1/01

(52) U.S. Cl. 340/933

(57) ABSTRACT

A lane detection apparatus for a host vehicle, the apparatus comprising: a first sensing means, which provides a first set of data dependent upon features of a part of the road ahead of the host vehicle; a second sensing means, which provides a second set of data dependent upon features of a part of the road ahead of the host vehicle; and a processing means arranged to estimate the location of lane boundaries by interpreting the data captured by both sensing means. The second sensing means may have different performance characteristics to the first sensing means. One or more of the sensing means may include a pre-processing means, which is arranged to process the “raw” data provided by the sensing means to produce estimated lane boundary position data indicative of an estimate of the location of lane boundaries. The fusion of the data points can be performed in many ways, but in each case the principle is that more reliable raw data points or de-constructed data points are given preference over, or are more dominant than, less reliable data points. How reliable the points are at a given range is determined by allocating a weighting to the data values according to which sensing means produces the data and to what range the data values correspond.

This application is a continuation of International Application No. PCT/GB2004/003291 filed Jul. 29, 2004, the disclosures of which are incorporated herein by reference, and which claimed priority to Great Britain Patent Application No. GB 03 17 949.6 filed Jul. 31, 2003, the disclosures of which are incorporated herein by reference.

### BACKBROUND OF THE INVENTION

This invention relates to improvements in sensing apparatus for vehicles. It in particular but not exclusively relates to a lane boundary detection apparatus for a host vehicle that is adapted to estimate the location of the boundaries of a highway upon which the host vehicle is located.

In recent years the introduction of improved sensors and increases in processing power have led to considerable improvements in automotive control systems. Improvements in vehicle safety have driven these developments, which are approaching commercial acceptance. One example of the latest advances is the provision of a Lane Departure Warning (LDW) system. This system uses information about the boundaries of lanes ahead of the vehicle and information about vehicle dynamics to warn the driver if they are about to exit a lane. Current LDW systems are structured around position sensors, which detect feature points that lie on boundaries.

The detection of lane boundaries is typically performed using a video, LIDAR or radar based sensor mounted at the front of the host vehicle. The sensor identifies the location of detected objects relative to the host vehicle and feeds this information to a processor. The processor determines where the boundaries are by identifying artifacts in the image and fitting these to curves.

### BRIEF SUMMARY OF THE INVENTION

In accordance with a first aspect, the invention provides a lane detection apparatus for a host vehicle, the apparatus comprising: a first sensing means, which provides a first set of data dependent upon features of a part of the road ahead of the host vehicle; a second sensing means, which provides a second set of data dependent upon features of a part of the road ahead of the host vehicle; and a processing means arranged to estimate the location of lane boundaries by interpreting the data captured by both sensing means.

The second sensing means may have different performance characteristics to the first sensing means.

One or more of the sensing means may include a pre-processing means, which is arranged to process the “raw” data provided by the sensing means to produce estimated lane boundary position data indicative of an estimate of the location of lane boundaries. The estimate of a lane position may be produced by fitting points in the raw data believed to be part of a lane boundary into a curve or a line. These “higher level” estimates of lane boundary location may be passed to the processing means rather than the raw data with the processing means producing modified estimates of the location of lane boundaries from the higher level data produced from both sensing means.

The pre-processing may be performed local to the capture of the raw data and the estimates then passed across a network to the processing means. This is preferred as it reduces the amount of data that needs to be sent across the network to the processing means.

The processing means may be arranged to receive the estimates of lane boundary position from the sensing or pre-processing means and to deconstruct these estimates to produce data points indicative of the position of points on the estimated boundaries at a plurality of preset ranges. Alternatively, the raw data may be analysed to generate a set of data points indicative of the position of points on the boundary at those ranges. Therefore, deconstructed data or raw data may be used by the processing means.

The processing means may combine or fuse the raw data or the deconstructed data or a mixture of raw data and deconstructed data from the two sensing means to produce a modified set of data points indicative of the location of points on the boundary at the chosen ranges. These modified points may subsequently be fitted to a suitable set of equations to establish curves or lines which express the location of the lane boundaries.

The fusion of the data points can be performed in many ways, but in each case the principle is that more reliable raw data points or de-constructed data points are given preference over, or are more dominant than, less reliable data points. How reliable the points are at a given range is determined by allocating a weighting to the data values according to which sensing means produced the data and to what range the data values correspond.

The processing means may allocate weightings to the raw or deconstructed data-or to other data derived therefrom-from the two sets of data dependent upon the performance characteristics of the first and second sensing means to produce a set of weighted data and to process the weighted data to produce an estimate of the position of at least one lane boundary.

The performance characteristics of the two sensing means may differ in that the first sensing means may be more accurate for the measurement of distant objects than the second sensing means, which in turn may be more accurate for the measurement of objects at close range than the first sensing means. In this case, distant objects identified by the first sensing means may be given a higher weighting - or confidence value-than the same object identified by the second sensing means. Similarly, near objects detected by the second sensing means will be given a higher weighting or confidence value.

The apparatus may include a memory, which can be accessed by the processor and which stores information needed to allocate the weightings to the data points. This may comprise one or more sets of weighting values. They may be stored in a look-up table with the correct weighting for a data point being accessed according to its range and the sensing means which produced it. For example, the memory may store a set of weightings corresponding to a plurality of ranges, i.e. 10 m, 20 m, 30 m and 50 m. In an alternative, an equation may be held in the memory, which requires as its input a range and the identity of the sensing means, and produces as its output a weighting.

Both sensing means may view portions of the road that at least partially overlap such that a lane boundary on the road may appear in the data sets produced by both sensing means. Of course, they need not overlap. One sensing means could sense one portion of a lane boundary and the other a different portion. In both cases, a lane boundary location may be produced for the complete lane boundary from both sensing means.

Thus, in at least one embodiment the invention provides for the combination, or fusion, of information from two different sensing means of differing range-dependent characteristics to enable the location of the lanes to be determined. The invention enables each sensing means to be dominant over the range and angular position of lane artifacts that it is best suited to by weighting the data from the sensing means. A set of data points may be formed in this way, which is fitted to a line or curve with some of the data points being taken from one sensing means and some from the other, or perhaps the two may be weighted and averaged.

The pre-processing may comprise an edge detection technique or perhaps an image enhancement technique (e.g. sharpening of the image) by modifying the raw pixellated data. The processing means may, for example, further include a transformation algorithm, such as an inverse perspective algorithm, to convert the edge detected points of the lane boundaries from the image plane to processed data points in the real world plane.

In addition to the application of weightings to the data points to assist in the fusion of data points, the processing means may also apply a confidence value to the raw data or the de-constructed data or to the weightings from each sensing means. This confidence value will be determined independently of the weighting values according to how confident the apparatus is about the data from each sensing means. For example, if the environment in which the data sets are captured is difficult-e.g. if images are captured in the rain or at low light levels-a lower confidence level may be applied to the data from one sensing means than the other, if they each deal with that environment differently. One sensing means may be more tolerant of rain than the other and so be more confident in the validity of the data. The confidence value may be added to, subtracted from, multiplied with or otherwise combined with a weighting value allocated to a data point to produce a combined confidence/weighting value.

It will be appreciated that as a general rule the weightings will be fixed for a given range and location of a data point in an image from the sensing means whilst the confidence values may vary over time depending upon the operating environment.

The processing means may be adapted to determine the environment from the captured data-e.g. filtering to identify raindrops on a camera-or from information passed to it by other sensing means associated with the host vehicle.

The processing means may filter the data from the two sensing means to identify points in the image corresponding to one or more of: the right hand edge of a road, the left hand edge of the road, lane markings defining lanes in the road, the radius of curvature of the lane and or the road, and optionally the heading angle of the host vehicle relative to the road/lane. These detected points may be processed to determine the path of the lane boundaries ahead of the host vehicle.

The first and second sensing means may produce a stream of data over time by capturing a sequence of data frames. The frames may be captured at a frequency of 10 Hz or more, i.e. one set of data forming an image is produced every 1/10ₜₕ of a second or less. Newly produced data may be combined with old data to update an estimate of the position of lanes in the captured data sets.

The processing means may be adapted to fuse the data points and weightings using one or more recursive processing techniques. By recursive we mean that the estimates are updated each time new data is acquired taking into consideration the existing estimate. The techniques that could be employed within the scope of the invention include a recursive least squares (RLS) estimator or other process such as a Kalman filter which recursively produces estimates of lane boundaries taking into consideration the weightings applied to the data and optionally the confidence values. This means that the weightings are input to the filter along with the data points and influence the output of the filter.

In effect, all of the data points-raw or de-constructed or a combination of both-from each of the two sensing means, are processed to estimate the lane positions.

By lane boundaries, we may mean physical boundaries such as barriers or paint lines along the edge of a highway or lane of a highway or other features such as rows of cones marking a boundary or a change in the highway material indicating an edge.

The first sensing means may comprise a laser range fmder often referred to as a LIDAR type device. This may have a relatively wide field of view-up to say 270 degrees. Such a device produces accurate data over a relatively short range of up to, say, 20 or 30 metres depending on the application.

The second sensing means may comprise a video camera, which has a relatively narrow field of view-less than say 30 degrees-and a relatively long range of more than 50 metres or so depending on the application.

Both sensing means may be fitted to part of the vehicle although it is envisaged that one sensing means could be remote from the vehicle, for example a satellite image system or a GPS driven map of the road.

Whilst video sensing means and LIDAR have been mentioned, the skilled man will appreciate that a wide range of sensing means may be used. A sensing means may comprise an emitter which emits a signal outward in front of the vehicle and a receiver which is adapted to receive a portion of the emitted signal reflected from objects in front of the vehicle, and a target processing means which is adapted to determine the distance between the host vehicle and the object.

It will be appreciated that the provision of apparatus for identifying the location of lane boundaries may also be used to detect other target objects such as obstacles in the path of the vehicle-other vehicles, cyclists etc.

According to a second aspect, the invention provides a method of estimating the position of lane boundaries on a road ahead comprising: capturing a first frame of data from a first sensing means and a second frame of data from a second sensing means; and fusing the data-or data derived therefrom-captured by both sensing means to produce an estimate of the location of lane boundaries on the road.

The first sensing means may have different performance characteristics to the second sensing means.

The fusion step of the method may include the steps of allocating weightings to data points indicative of points on the lane boundaries estimated by both sensing means at a plurality of ranges and processing the data points together with the weightings to provide a set of modified data points.

The fusion step may comprise passing the data points and the weighting through a filter, such as an RLS estimator.

The method may further comprise allocating a confidence value to each sensing means dependent upon the operating environment in which data was captured and modifying the weightings using the confidence values.

The method may comprise generating the data points for at least one of the sensing means by producing higher level data in which the lane boundaries are expressed as curves and subsequently deconstructing the curves by calculating the location in real space of data points on the curves at a plurality of preset ranges. These de-constructed data points may be fused with other de-constructed data points or raw data points to establish estimates of lane boundary positions.

According to a third aspect the invention provides a computer program which when running on a processor causes the processor to perform the method of the second aspect of the invention.

The program may be distributed across a number of different processors. For example, method steps of capturing raw data may be performed on one processor, generating higher level data on another, deconstructing the data on another processor, and fusing on a still further processor. These may be located at different areas.

According to a fourth aspect of the invention, the invention provides a computer program which, when running on a suitable processor, causes the processor to act as the apparatus of the first aspect of the invention.

According to a fifth aspect of the invention, there is provided a data carrier carrying the program of the third and forth aspect of the invention.

According to a sixth aspect the invention provides a processing means which is adapted to receive data from at least two different sensing means, the data being dependent upon features of a highway on which a vehicle including the processing means is located and which fuses the data from the two sensing means to produce an estimate of the location of lane boundaries of the highway relative to the vehicle.

The processing means may be distributed across a number of different locations on the vehicle.

Other advantages of this invention will become apparent to those skilled in the art from the following detailed description of the preferred embodiments, when read in light of the accompanying drawings.

### BRIEF DESCRIPTION OF THE DRAWINGS

FIG. 1 illustrates a lane boundary detection apparatus fitted to a host vehicle and shows the relationship between the vehicle and lane boundaries on the highway;

FIG. 2 is an illustration of the detection regions of the two sensors of the apparatus of FIG. 1;

FIG. 3 illustrates the fusion of data from the two sensors;

FIG. 4 is an example of the weightings applied to data points obtained from the two sensors at a range of distances;

FIG. 5 illustrates the flow of information through a second example of a lane boundary detection apparatus in accordance with the present invention;

FIG. 6 illustrates the flow of information through a second example of a lane boundary detection apparatus in accordance with the present invention;

FIG. 7 is a general flow chart illustrating the steps carried out in the generation of a model of the lane on which the vehicle is travelling from the images gathered by the two sensors; and

FIG. 8 illustrates the flow of information through a second example of a lane boundary detection apparatus in accordance with the present invention.

### DETAILED DESCRIPTION OF THE INVENTION

The system of the present invention improves on the prior art by providing for a lane boundary detection apparatus that detects the location of lane boundaries relative to the host vehicle, by fusing data from two different sensors. This can be used to determine information relating to the position of the host vehicle relative to the lane boundaries, the lane width and the heading of the vehicle relative to the lane in order to estimate a projected trajectory for the vehicle.

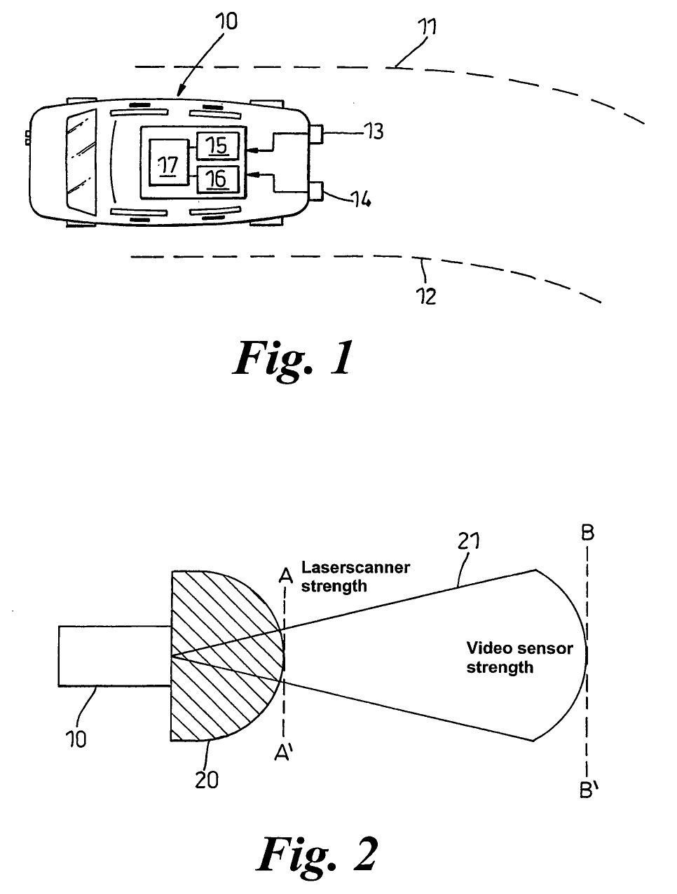

The apparatus required to implement the system is illustrated in FIG. 1 of the accompanying drawings, fitted to a host vehicle 10. The vehicle is shown as viewed from above on a highway, and is in the centre of a lane having left and right boundaries 11,12. In its simplest form, it comprises two sensing or image acquisition means—a video camera 13 mounted to the front of the host vehicle 10 and a LIDAR sensor 14. The camera sensor 13 produces a stream of output data, which are fed to an image processing board 15. The image processing board 14 captures images from the camera in real time. The radar or LIDAR type sensor 14 is a Laserscanner device, which is also mounted to the front of the vehicle 101 and which provides object identification and allows the distance of the detected objects from the host vehicle 10 to be determined together with the bearing of the object relative to the host vehicle. The output of the LIDAR sensor 14 is also passed to an image processing board 16 and the data produced by the two image processing boards 15,16 is passed to a data processor 17 located within the vehicle which combines or fuses the image and object detection data.

The fusion ensures that the data from one sensor can take preference over data from the other, or be given more significance than the other-according to the performance characteristics of the sensors and the range at which the data is collected. As illustrated in FIG. 2 of the accompanying drawings, the two sensors have different performance characteristics. The field of view and range of the LIDAR sensor is indicated by the hatched cone 20 projected in front of the host vehicle, viewed from above. The sensor can detect objects such as lane boundary markings within the hatched cone area. The detection area of the video sensor is similarly illustrated by the unhatched cone shaped area 21.

For the detection of lane offsets close to the vehicle (<1 meter) the LIDAR is more accurate as it has a very wide field of view, whereas the narrow field of view of the video camera makes it less accurate. On the other hand, measuring lane curvature at long ranges (>20 m) the video is more accurate than the LIDAR. Of course, the skilled man will understand that the sensors described herein are mere examples, and other types of sensor could be provided. Indeed, two video sensors could be provided with different fields of view and focal lengths, or perhaps two different LIDAR sensors. The invention can be applied with any two sensors provided they have different performance characteristics.

The data processor performs both low level imaging processing and also higher level processing functions on the data points output from the sensors.

The processor implements a tracking algorithm, which uses an adapted recursive least-squares technique in the estimation of the lane model parameters. This lane model has a second order relationship and can be described (equation 1 below) as:
x=c₁+c₂z+c₃z² (1)
where c₁ corresponds to the left/right lane marking offset, c₂ is the lane heading angle and C₃ is the reciprocal of twice the radius of curvature of 5 the lane.

The output from the data processor following application of these algorithms (or other processing) fully describes the road on which the host vehicle is travelling. Looked at one way, the processor fits points that it believes to be part of a lane boundary to a curve, which is given by equation 1.

Two different strategies may be employed by the processing means 17 to fuse the data from the two sensors. The strategies depend upon whether the data from the sensors is “higher level”, by which we mean data that has undergone some pre-processing to estimate lane positions, or lower level data, by which we typically mean raw data from the sensors. In each case, a technique based around a recursive least squares (RLS) method is used. Other estimators could, of course, be used such as Kalman filters.

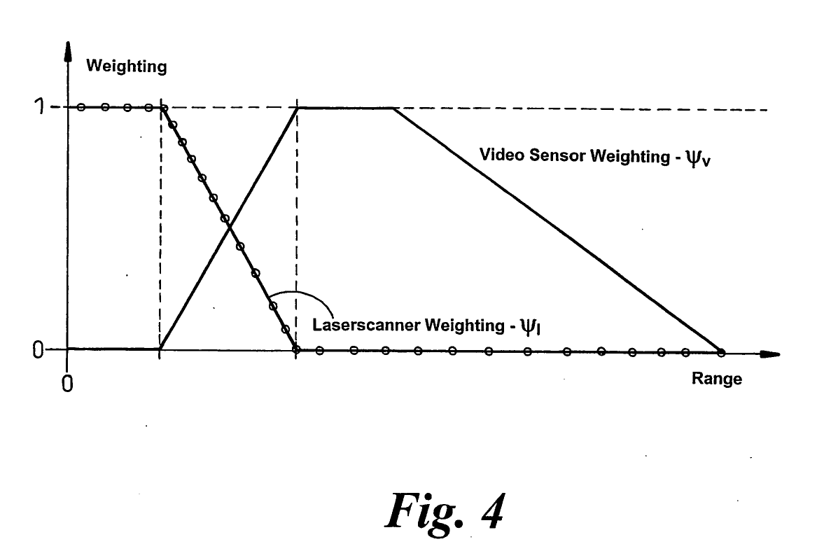

In order to fuse the data from the two sensors, a set of data points that are believed to lie on a line boundary are identified in the raw data. A weighting is then allocated to each data point indicating how reliable the data point is believed to be. This weighting is dependent upon the performance characteristics of each sensor and will be a function of range. The weighting value is varied with range depending on how likely the data sample point is likely to be as defined by the limitation of the sensor within the operating environment. Hence, in the example given data points from the LIDAR data are weighted more heavily in the near range than the data points form the video data, whilst the video data is weighted more heavily in the distance. Typical plots of weighting value against range are illustrated in FIG. 4 of the accompanying drawings.

As well as applying a weighting to the data, an overall confidence value for the data from each is also generated which is taken into account in the fusion process. The confidence value is generated according to the environment in which the images are captured, e.g. raining or poor light levels, and may be different for each sensor depending on how well they deal with different environmental conditions.

Having generated confidence and weighting values as well as a set of data points that are believed to lie on a lane boundary, the exemplary methods of data fusion assume that the constraints of the boundary model follow the relationship of equation 1. An RLS estimator is designed which solves the following problem:
y=θX . . . (2)
where y is the measurement, 0 is the parameter to be estimated and X is the data vector. Such an RLS estimator is well documented, for example in “Factorisation Methods for discrete sequential estimation” by Gerald J Bierman. For the avoidance of doubt, the teaching of that disclosure is incorporated herein by reference. A summary of the estimator structure is as follows:
eᵥ=yᵥ−θ_{n—l}Xv . . . (3)
eₗ=yₗ—θ_{n—l}X . . . (4)
θₙ=θn—1+KₙeᵥΨᵥ+Kₙe_{lΨ}ₗ. . (5)
Where e is the error (subscript v refers to data for the video sensor whilst subscript 1 refers to the LIDAR sensor), K is the estimator gains and w is the variable weighting factor applied to each data point. The weighting factor is determined by reference to the functions shown in FIG. 4 of the accompanying drawings but also scaled according to the confidence value output by each sensors image processing board.

The RLS estimator is tuned by varying the number of data points in the data set and the weighting values for each data point. The weighting values are generated by the data point weighting block and will be a function of range and sensor confidence but may be a function of other measurements as well or instead. The weights are in this example normalised and distributed at all instants such that:
0<θ.+θ,<1 . . . . . . . . (6)

This means that the normalised values of the weightings can be reduced for less accurate data (e.g. measurements further from the vehicle).

Three typical methods of estimating lane boundaries using data fusion from two sensors are set out hereinbelow:

Method 1 —High Level Data

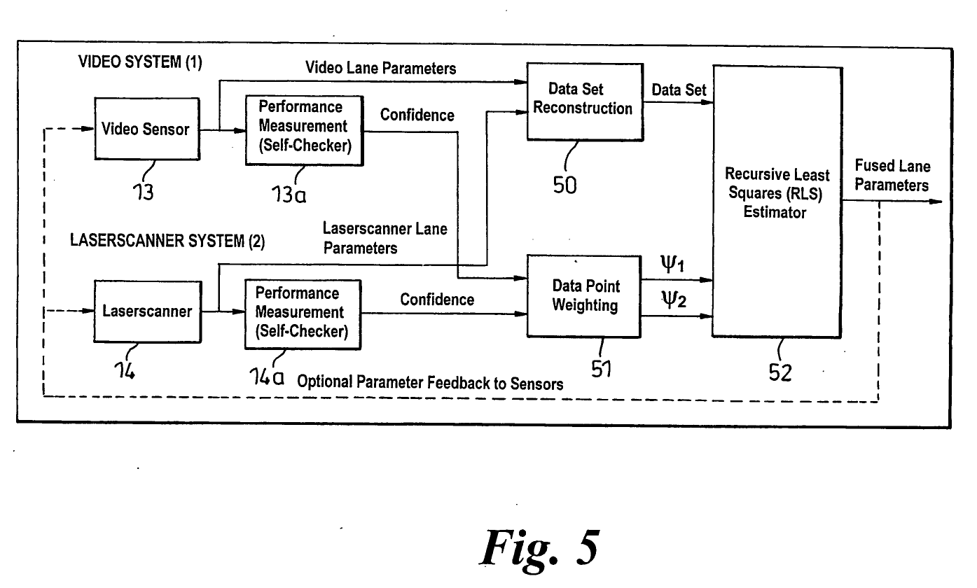

In this first method, as shown in the block diagram of FIG. 5 which shows the flow of information through the system, each sensor 13, 14 produces raw data which is passed to the image processing boards 13aand 14a. The boards process the raw captured data to identify points that lie on boundaries in real space and also provide a self check function 13a, 14a. A confidence value is also produced by each image processing board for each image. The boundary data points from both sensors are fitted to appropriate curves such as those defined by equation (1) and the parameters of the curves are passed to the processor. These curves are referred to in this text as examples of “higher level” data.

The processor, on receiving the higher level data, de-constructs the data to produce a set of deconstructed data points. These are obtained by solving the equations at a set of ranges, e.g. 10 m, 20 m, 30 m 40 m and 50 m. The ranges are chosen to correspond with the ranges for which weightings are held in a memory accessible by the processing means. The processing boards 13a, 14a also generate a confidence value indicative of the reliability of the higher level data. The confidence values, which may change over time, the deconstructed data points and the weighting are combined by a weighting stage 51 to produce weighting values for the two data sets. The data set and the weightings are then fed into an RLS estimator 52 which outputs a representation of a model describing the or each lane that is “seen” by the sensor.

The confidence value and the weighting values assigned to a lane estimate are dependent upon the characteristics of the sensor, and a different weighting will be applied for a given combination of range/position within the field of view. Since only higher level data needs to be passed from the image processing boards to the processor, the amount of data moving through the system is relatively low compared with sending raw data.

Method 2—Mixed High and Low Level Data

A second method is shown in FIG. 8 of the accompanying drawings, showing the flow of information through the method. Fusion of information still occurs by passing data points, weightings and confidence values through an RLS estimator, but in this case the data that is fused comprises data points produced directly by the processor from the raw LIDAR data, and de-constructed data points from higher level video data.

The LIDAR therefore sends raw data to the processor instead of high level data, allowing the deconstruction stage to be omitted.

Method 3—Low level data

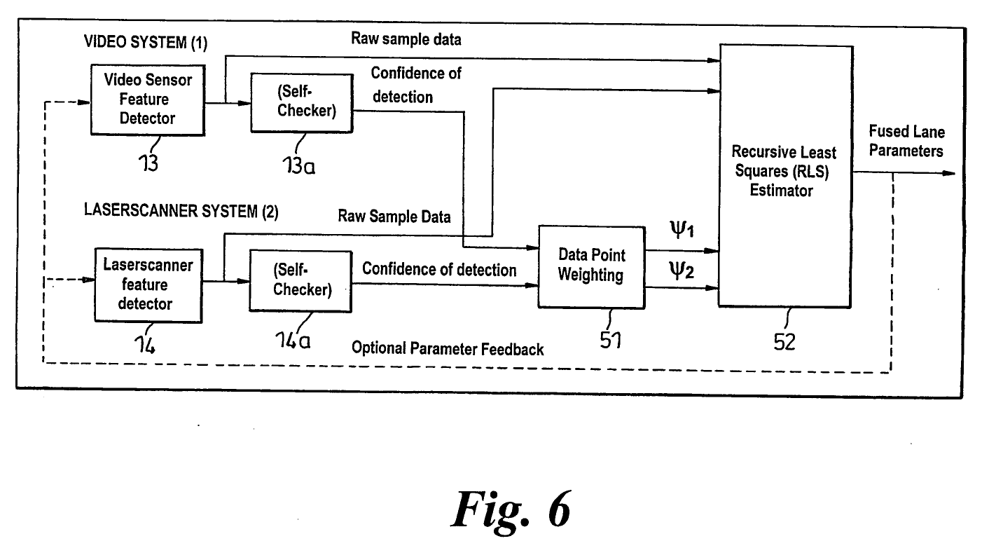

In this third method, the information flow through which is shown in FIG. 6 of the accompanying drawings, low level data from both sensors is used to drive the RLS estimator. In a similar manner to the second method, raw data from the LIDAR and now the video sensor are fused to determine lane boundary positions. Deconstruction of both data sets can therefore be omitted.

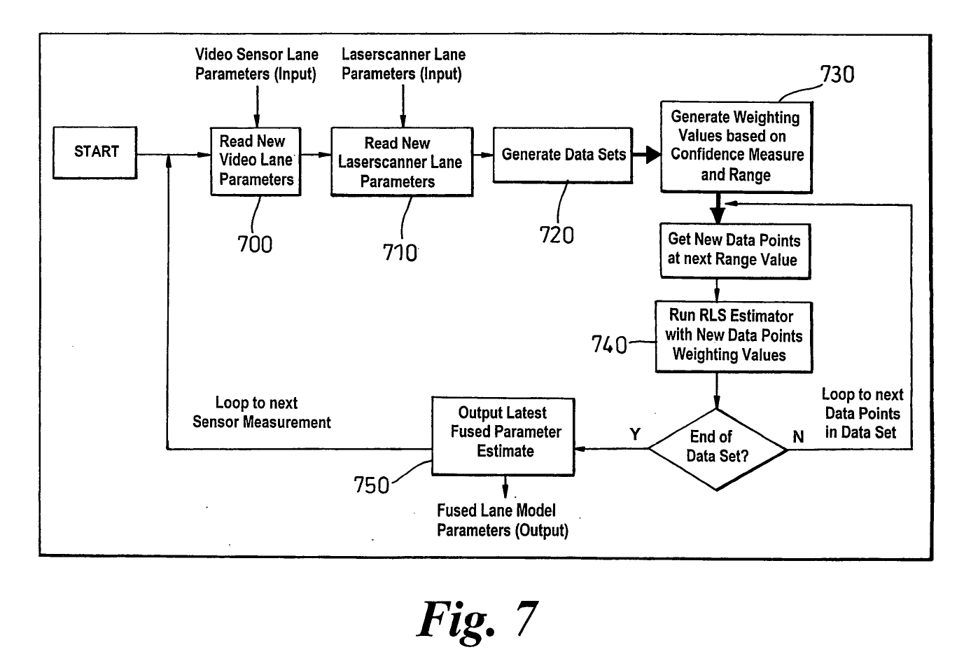

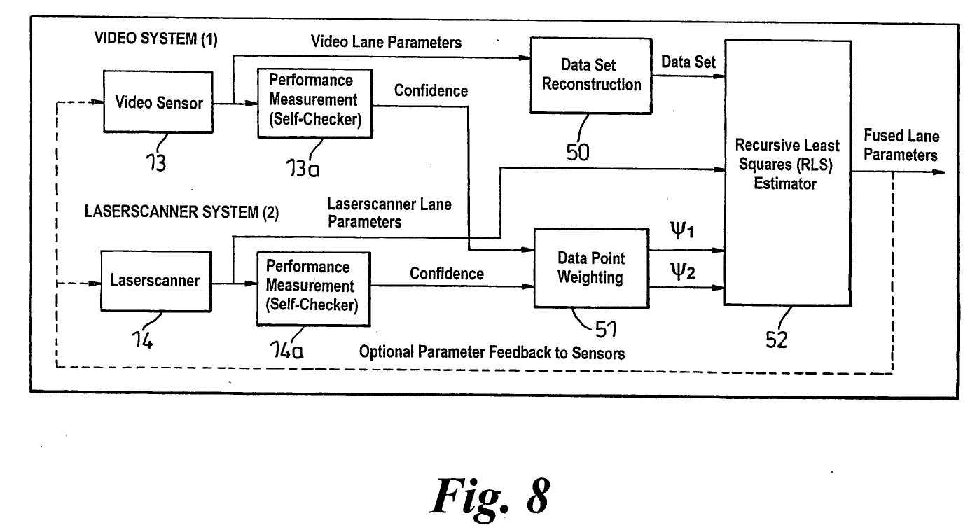

FIG. 7 is a flow chart showing the steps performed for each sensor measurement in a general processing scheme. In a first step 700 a set of new video lane parameters are read from the data produced by the video sensor, followed in step 710 by the reading of a set of new LIDAR lane parameters derived from the data produced by the LIDAR sensor. Two data sets are then generated 720 from the two sets of readings which may be high level or low level data and from this two sets of data points which comprise points that lie on a boundary are produced. A weighting value 730 is assigned to each data point based upon its range and a confidence measure.

In a subsequent step, an initial range value is chosen and each of the data points from the two sets at the chosen range are selected together with their weighting value. The RLS estimator is then applied 740 to fuse together the selected data points. Generally, the points with the highest weighting will be dominant in the estimate.

The next range value is then selected 735 and the data points at the new range are fused until the whole range has been swept. At this time, the used estimate values from the estimator are output 750 as a fused lane estimate model and the next set of data points are read from the two sensors. The steps 700 to 750 are then repeated.

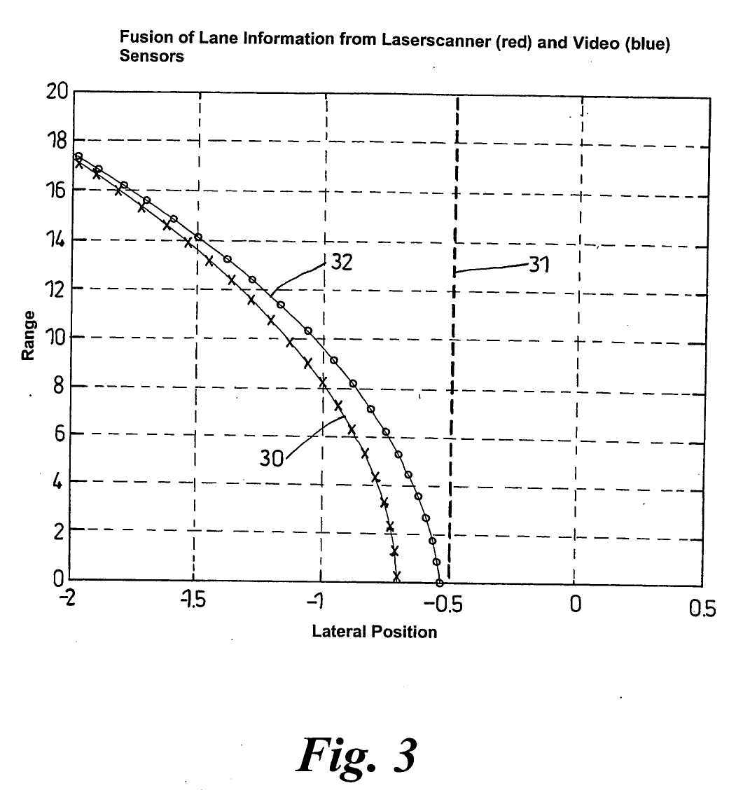

As shown in FIG. 3 of the accompanying drawings, which is a plot of range against lane boundary lateral position, the results of the two types of sensor clearly vary with range yet the present invention fuses the two sets of results to bias the output towards the video camera at long ranges and the LIDAR at close ranges. The overall result is therefore optimized at all ranges. The crossed line 30 represents the results that would be obtained from video alone, the dashed line 31 from LIDAR alone. The present invention provides results indicated by the dotted line 32.

The skilled man will understand that whilst RLS estimators have been described for perming data fusionit can be performed in other ways. For example, in a very simple model the most reliable data point at any given range may be chosen such that the data point from one sensor is always used at a given range whilst a data point from the other sensor may be use at a different range. The two data points could be average to produced a new data point that lies somewhere between them and is closer to one thatn the other according to their relative weightings.

In accordance with the provisions of the parent statutes, the principle and mode of operation of the invention have been explained and illustrated in its preferred embodiment. However, it may be understood that this invention may be practiced otherwise than as specifically explained and illustrated without departing from its spirit or scope.

1. A lane detection apparatus for a host vehicle, the apparatus comprising:
a means sensor which provides a first set of data dependent upon features of a part of a road ahead of the host vehicle;
a second sensor which provides a second set of data dependent upon features of a part of the road ahead of the host vehicle; and
a processor arranged to estimate the location of lane boundaries by interpreting the captured by both sensors.

2. The apparatus of claim 1 in which wherein the second sensor has different performance characteristics to the first sensor.

3. The apparatus of claim 1 wherein the processor is arranged to analyse the data to generate a set of data points indicative of the position of points on the lane boundaries at a plurality of preset ranges.

4. The apparatus of claim 1, wherein at least one of the sensors includes a pre-processing means, which is arranged to process raw data provided by the sensors to produce estimated lane boundary position data indicative of an estimate of location of the lane boundaries.

5. The apparatus of claim 4 wherein the pre-processing means is arranged to produce the estimate of a lane position by fitting points in the data believed to be part of a lane boundary into one or more of a curve and a line.

6. The apparatus of claim 4 wherein the pre-processing means is arranged to process data local to capture of the data, the apparatus fuirther comprising a network over which the estimates can be passed to the processor.

7. The apparatus of claim 4, wherein the processor is arranged to receive estimates of lane boundary position from the pre-processing means and to de-construct these estimates to produce data points indicative of the position of points on the estimated boundaries at a plurality of preset ranges.

8. The apparatus of claim 7, wherein the processing means is arranged to combine data from the two sensors to produce a modified set of data points indicative of the location of points on the boundary at the preset ranges.

9. The apparatus of claim 8 wherein the processor is arranged to fit the modified points to a suitable set of equations to establish one or more of a curve and a line which express the location of the lane boundaries.

10. The apparatus of claim 1, wherein the processor is arranged to give preference to data points determined to be more reliable over less reliable data points.

11. The apparatus of claim 10 wherein the processor is arranged to allocate a weighting to the data values according to which the sensor produced the data and to the range to which the data values correspond.

12. The apparatus of claim 10 in which the wherein performance characteristics of the two sensors differ in that the first sensor is more accurate for the measurement of distant objects than the second sensor, which in turn is more accurate for the measurement of objects at close range than the first sensor.

13. The apparatus of claim 12 wherein the processor is arranged to give distant objects identified by the first sensor a higher weighting than the same object identified by the second sensor.

14. The apparatus of claim 12 wherein the processor is arranged to give near objects detected by the second sensor a higher weighting.

15. The apparatus of claim 10, wherein the apparatus includes a memory, which is arranged to be accessed by the processor and arranged to store information needed to allocate the weightings to the data points.

16. The apparatus of claim 3, wherein the pre-processing means is arranged to perform an edge detection technique or an image enhancement technique to modify the raw data.

17. The apparatus of claim 10, wherein, in addition to being arranged to apply to weightings to the data points the processing means is arranged to apply a confidence value to the data value being determined independently of the weighting values according to how confident the apparatus is about the data from each sensing means sensor.

18. The apparatus of claim 17 wherein the processor is arranged to fix the weightings for a given range and location of a data point in an image from the sensors but to allow the confidence values to vary over time depending upon the operating environment.

19. The apparatus of claim 11 wherein the processor is adapted to fuse the data points and weightings using at least one recursive processing technique.

20. The apparatus of claim 1 wherein first sensor comprises a range finder.

21. The apparatus of claim 20 in whichl1 wherein the second sensor comprises a video camera.

22. The apparatus of claim 21 wherein, with respect to the range finder, the video camera has a relatively narrow field of view and a relatively long range.

23. The apparatus of claim 1 wherein both sensors are arranged to be fitted to part of the vehicle.

24. The apparatus of claim 1 wherein one sensing means sensor is arranged to be remote from the vehicle.

25. The apparatus of claim 20 wherein the range finder is a laser range finder.

26. A method of estimating the position of lane boundaries on a road ahead comprising:
capturing a first frame of data from a first sensor and a second frame of data from a second sensor; and
fusing the data captured by both sensors to produce an estimate of the a location of lane boundaries on said road.

27. The method of claim 26 wherein the first sensor has different performance characteristics to the second sensor.

28. The method of claim 26 wherein the fusing step includes the steps of allocating weightings to data points indicative of points on the lane boundaries estimated by both sensors at a plurality of ranges and processing the data points together with the weightings to provide a set of modified data points.

29. The method of any fusion step comprises passing the data points and weightings through a filter.

30. The method of claim 28, further comprising allocating a confidence value to each sensing means dependent upon the operating environment in which data was captured and modifying the weightings using the confidence values.

31. The method of claim 26, comprising generating the data points for at least one of the sensors by producing higher level data in which the lane boundaries are expressed as curves and subsequently deconstructing the curves by calculating a location in real space of data points on the curves at a plurality of preset ranges.

32. The method of claim 31 wherein the de-constructed data points are fused with other de-constructed data points or raw data points to establish estimates of lane boundary positions.

33. A computer program which when running on a processor causes the processor to perform a method of claim 26.

34. The program of claim 33 wherein the program is distributed across a number of different processors, located at different areas.

35. A computer program which, when running on a suitable processor, causes the processor to act as apparatus of claim 1.

36. A data carrier carrying the program of claim 33.

37. A processing means which is adapted to receive data from at least two different sensors, the data being dependent upon features of a highway on which a vehicle including the processing means is located and which fuses the data from the sensors to produce an estimate of a location of lane boundaries of the highway relative to the vehicle.

38. The processing means of claim 37 wherein the processing means is distributed across a number of different locations on the vehicle.

39. The method of claim 29 wherein the filter is an RLS estimator.
